(19) United States
(12) Patent Application Publication
(10) Pub. No.: US 2022/0101160 A1
(43) Pub. Date: Mar. 31, 2022

(54) MODEL REUSE-BASED MODEL PREDICTION

(71) Applicant: ALIPAY (HANGZHOU) INFORMATION TECHNOLOGY CO., LTD., Hangzhou (CN)

(72) Inventors: Chaochao Chen, Hangzhou (CN); Li Wang, Hangzhou (CN); Jun Zhou, Hangzhou (CN)

(73) Assignee: ALIPAY (HANGZHOU) INFORMATION TECHNOLOGY CO., LTD., Hangzhou (CN)

(21) Appl. No.: 17/361,007

(22) Filed: Jun. 28, 2021

(30) Foreign Application Priority Data
Sep. 25, 2020 (CN) 202011023294.1

(51) Int. Cl. G06N 5/04; G06N 20/00

(52) U.S. Cl. CPC G06N 5/04; G06N 20/00

(57) ABSTRACT

One or more embodiments of the present specification relate to a model reuse-based model prediction method, apparatus, and system. An example method includes, for each reusable prediction model of a plurality of reusable prediction models, using the reusable prediction model to obtain a respective predicted label of the reusable prediction model, by performing secure computing between an owner of to-be-predicted data and an owner of the reusable prediction model. A predicted label of the to-be-predicted data is determined based on each respective predicted label of each reusable prediction model and a model weight of each reusable prediction model, the model weight of each reusable prediction model being a model weight in a data sample set of the owner of the to-be-predicted data.

### CROSS-REFERENCE TO RELATED APPLICATIONS

This application claims priority to Chinese Patent Application No. 202011023294.1, filed on Sep. 25, 2020, which is hereby incorporated by reference in its entirety.

### TECHNICAL FIELD

Embodiments of the present specification generally relate to the field of artificial intelligence, and in particular, to model reuse-based model prediction methods, model prediction apparatuses, and model prediction systems.

### BACKGROUND

Model reuse is a technology in the field of machine learning. When there is a model prediction task, model prediction can be performed based on existing prediction models without a need to train new prediction models to reuse these existing prediction models, thereby saving model training time of prediction models. When there is new to-be-predicted data, how to implement model prediction on a basis of ensuring data and model privacy security is a problem to be resolved.

### SUMMARY

In view of the previous description, embodiments of the present specification provide model reuse-based model prediction methods, model prediction apparatuses, and model prediction systems. In the model prediction solutions, model reuse-based model prediction can be implemented on a basis of ensuring data and model privacy security.

According to an aspect, the embodiments of the present specification provide a model reuse-based model prediction method, including the following: to-be-predicted data of a data owner is respectively predicted by using each of multiple reusable prediction models of a model owner to obtain a predicted label of each reusable prediction model, where the predicted label is obtained by respectively performing secure computing on the to-be-predicted data and each reusable prediction model between the data owner and the model owner, and the multiple reusable prediction models have the same model input features; and a predicted label of the to-be-predicted data is determined based on the predicted label of each reusable prediction model and a model weight of each reusable prediction model, where the model weight of each reusable prediction model is a model weight in a data sample set of the data owner.

Optionally, in an example of the aspect, before the model prediction is performed, the method further includes the following: labeled data of the data owner is respectively predicted by using each reusable prediction model to obtain a predicted label of each reusable prediction model, where the predicted label is obtained by respectively performing secure computing on the labeled data and each reusable prediction model between the data owner and the model owner; a prediction error of each reusable prediction model is determined based on the predicted label of each reusable prediction model and a real label of the labeled data; and the model weight of each reusable prediction model is determined based on the prediction error of each reusable prediction model.

Optionally, in an example of the aspect, the model owner includes multiple model owners, and each of the multiple model owners has one or more of the multiple reusable prediction models.

Optionally, in an example of the aspect, the secure computing includes: secure computing based on secret sharing; secure computing based on homomorphic encryption; secure computing based on oblivious transfer; secure computing based on a garbled circuit; or secure computing based on a trusted execution environment.

Optionally, in an example of the aspect, the labeled data includes multiple pieces of labeled data, and the prediction error of each prediction model is an average error of prediction errors for the multiple pieces of labeled data.

Optionally, in an example of the aspect, the reusable prediction model includes a logistic regression model, a model parameter of each reusable prediction model is a model parameter matrix, and the to-be-predicted data is vector data; and the respectively predicting to-be-predicted data of a data owner by using each of multiple reusable prediction models of a model owner to obtain a predicted label of each reusable prediction model includes: respectively performing secure computing on each reusable prediction model of the model owner and the to-be-predicted data of the data owner between the data owner and the model owner to obtain a vector product of the model parameter of each reusable prediction model and the to-be-predicted data; and calculating an activation function of the vector product of each reusable prediction model as the predicted label of each reusable prediction model.

According to another aspect, the embodiments of the present specification provide a model reuse-based model prediction apparatus. The model prediction apparatus is applied to a data owner, and the model prediction apparatus includes: a model prediction unit, configured to respectively predict to-be-predicted data of the data owner by using each of multiple reusable prediction models of a model owner to obtain a predicted label of each reusable prediction model, where the predicted label is obtained by respectively performing secure computing on the to-be-predicted data and each reusable prediction model between the data owner and the model owner, and the multiple reusable prediction models have the same model input features; and a predicted label determining unit, configured to determine a predicted label of the to-be-predicted data based on the predicted label of each reusable prediction model and a model weight of each reusable prediction model, where the model weight of each reusable prediction model is a model weight in a data sample set of the data owner.

Optionally, in an example of the aspect, the model prediction apparatus further includes: a prediction error determining unit, configured to determine a prediction error of each reusable prediction model based on a predicted label obtained by performing model perdition on labeled data of the data owner by using each reusable prediction model and a real label of the labeled data; and a model weight determining unit, configured to determine the model weight of each reusable prediction model based on the prediction error of each reusable prediction model, where the predicted label of each reusable prediction model is obtained by the model prediction unit by respectively performing secure computing on the labeled data and each reusable prediction model between the data owner and the model owner.

Optionally, in an example of the aspect, the secure computing includes: secure computing based on secret sharing; secure computing based on homomorphic encryption; secure computing based on oblivious transfer; secure computing based on a garbled circuit; or secure computing based on a trusted execution environment.

Optionally, in an example of the aspect, the labeled data includes multiple pieces of labeled data, and the prediction error of each prediction model is an average error of prediction errors for the multiple pieces of labeled data.

Optionally, in an example of the aspect, the reusable prediction model includes a logistic regression model, a model parameter of each reusable prediction model is a model matrix, and the to-be-predicted data is vector data; and the model prediction unit includes: a secure computing module, configured to respectively perform secure computing on each reusable prediction model of the model owner and the to-be-predicted data of the data owner between the data owner and the model owner to obtain a vector product of the model parameter of each reusable prediction model and the to-be-predicted data; and a predicted label calculation module, configured to calculate an activation function of the vector product of each reusable prediction model as the predicted label of each reusable prediction model.

According to another aspect, the embodiments of the present specification provide a model reuse-based model prediction system, including: a data owner, including the previously described model prediction apparatus; and at least one model owner, where each model owner has one or more of multiple reusable prediction models.

According to another aspect, the embodiments of the present specification provide an electronic device, including: at least one processor; and a storage coupled to the at least one processor, where the storage stores instructions, and when the instructions are executed by the at least one processor, the at least one processor is enabled to perform the previously described model prediction method.

According to another aspect, the embodiments of the present specification provide a machine-readable storage medium, where the machine-readable storage medium stores executable instructions, and when the instructions are executed, the machine is enabled to perform the previously described model prediction method.

### BRIEF DESCRIPTION OF DRAWINGS

With reference to the following accompanying drawings, the essence and advantages of the content of the present specification can be further understood. In the accompanying drawings, similar components or features can have the same reference numeral.

FIG. 1 is a schematic architectural diagram illustrating an example of a model prediction system, according to embodiments of the present specification;

FIG. 2 is a flowchart illustrating an example of a model reuse-based model prediction method, according to embodiments of the present specification;

FIG. 3 is a flowchart illustrating an example of a model prediction process, according to embodiments of the present specification;

FIG. 4 is a flowchart illustrating an example of a process of determining a model weight of a reusable prediction model, according to embodiments of the present specification;

FIG. 5 is a block diagram illustrating an example of a model prediction apparatus in a data owner, according to embodiments of the present specification;

FIG. 6 is a block diagram illustrating an implementation example of a model prediction unit, according to embodiments of the present specification; and

FIG. 7 is a schematic diagram illustrating an electronic device configured to implement a model prediction process in a data owner, according to embodiments of the present specification.

### DESCRIPTION OF EMBODIMENTS

The subject matter described in the present specification is discussed with reference to example implementations. It should be understood that these implementations are discussed merely for enabling a person skilled in the art to better understand and then implement the subject matter described in the present specification, instead of limiting the protection scope, applicability, or examples described in the claims. The functions and arrangement of the discussed elements can be changed without departing from the protection scope of the content of the present specification. Each example can be omitted or replaced or various processes or components can be added to each example as needed. For example, the described method can be performed in a sequence different from the described sequence, and steps can be added, omitted, or combined. In addition, features described with respect to some examples can also be combined in other examples.

As used in the present specification, the term “include” and variants thereof indicate open terms and mean “including but not limited to”. The term “based on” means “at least partially based on”. The terms “one embodiment” and “an embodiment” each indicate “at least one embodiment”. The term “another embodiment” indicates “at least one other embodiment”. The terms such as “first” and “second” can refer to different objects or the same object. The following can include other definitions, either explicit or implicit. Unless explicitly stated in the context, one term has the same definition throughout the present specification.

Model reuse is a technology in the field of machine learning. By using the model reuse technology, when there is a model prediction task, model prediction can be performed based on existing prediction models of a model owner, without a need to train new prediction models, thereby saving model training time of prediction models. However, when model prediction is performed on to-be-predicted data of a data owner by using the existing prediction models of the model owner, privacy security of the data of the data owner and the prediction models of the model owner needs to be ensured.

In view of the previous description, the embodiments of the present specification provide a model reuse-based model prediction solution. In the model prediction solution, secure computing is performed on each reusable prediction model of a model owner and to-be-predicted data of a data owner to obtain a predicted label of each reusable prediction model, so that privacy security of the data of the data owner and the prediction models of the model owner can be implemented. In addition, when model prediction is performed on the to-be-predicted data, each reusable prediction model has a model weight in a data sample set of the data owner, so that the model weight of each reusable prediction model is more in line with a data feature of the data owner, thereby improving model prediction accuracy.

The model prediction method and the model prediction apparatus provided in the embodiments of the present specification can be implemented by using an electronic device, for example, a terminal device or a server device. In other words, the method can be implemented by using software or hardware installed in the terminal device or the server device. The server device includes but is not limited to a single server, a server cluster, a cloud server, a cloud server cluster, etc. The terminal device includes but is not limited to any one of intelligent terminal devices such as a smartphone, a personal computer (PC), a notebook computer, a tablet computer, an electronic reader, a web television, and a wearable device.

In the embodiments of the present specification, the term “model owner” can be a device or a device party that deploys or maintains a reusable prediction model (for example, a service model), such as a terminal device or a server device. The term “data owner” can be a device or a device party configured to locally collect data samples, such as an intelligent terminal device or a server device. No prediction model is deployed (or maintained) in the data owner.

In an actual application example, the model owner can be, for example, a server of a third-party payment platform, and the data owner can be, for example, a private data storage server or an intelligent terminal device of a different financial institution or medical institution.

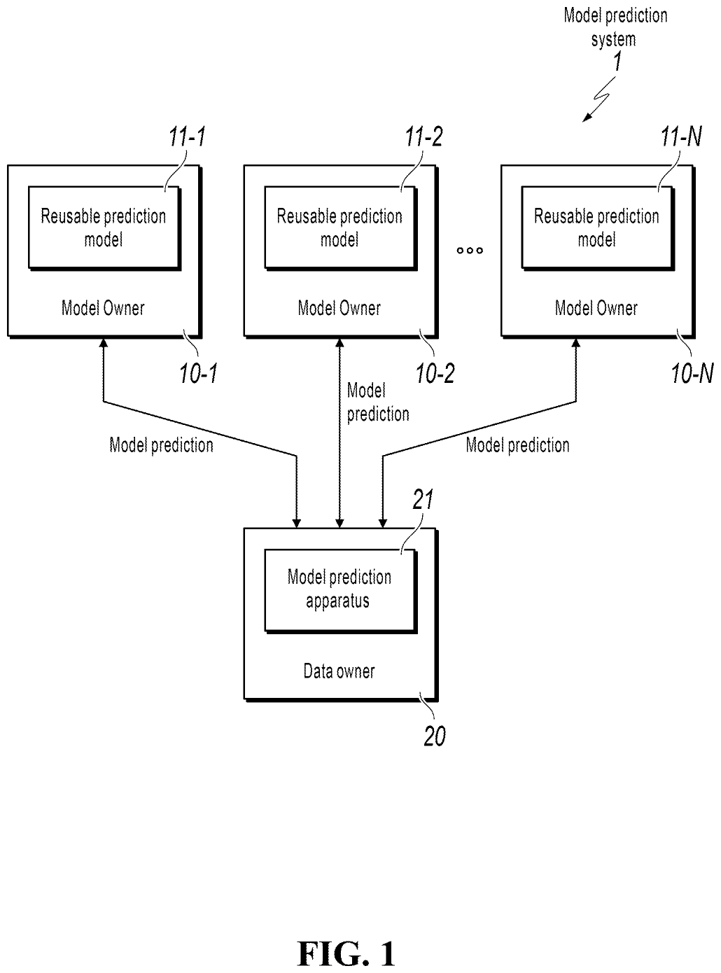

FIG. 1 is a schematic architectural diagram illustrating an example of a model prediction system 1, according to embodiments of the present specification.

As shown in FIG. 1, the model prediction system 1 includes a model owner 10 and a data owner 20. The model owner 10 has multiple reusable prediction models 11-1 to 11-N. Each reusable prediction model can be a pre-trained prediction model, for example, can be a prediction model trained by using data samples of data owners other than the data owner 20. In an example, the model owner 10 can include multiple model owners, and each of the multiple model owners can include one or more of the multiple reusable prediction models 11-1 to 11-N. For example, as shown in FIG. 1, the model owner 10 includes N model owners, and each model owner has one reusable prediction model. Here, the multiple reusable prediction models 11-1 to 11-N have the same model input features.

The data owner 20 is configured to locally collect data samples, for example, feature data of a service object. An example of the service object can include a user, a product, an event, or a relationship. Correspondingly, the data samples can include user feature data, product feature data, event feature data, or relationship feature data.

The data owner 20 has a model prediction apparatus 21. When model prediction is performed, the model prediction apparatus 21 respectively performs model prediction jointly with each of the model owners 10-1 to 10-N to obtain a model prediction result of each reusable prediction model, and obtains a model prediction result (a predicted label) of to-be-predicted data based on the model prediction result of each reusable prediction model and a model weight of each reusable prediction model in a data sample set of the data owner 20. The structure and operations of the model prediction apparatus 21 are described in detail below with reference to the accompanying drawings.

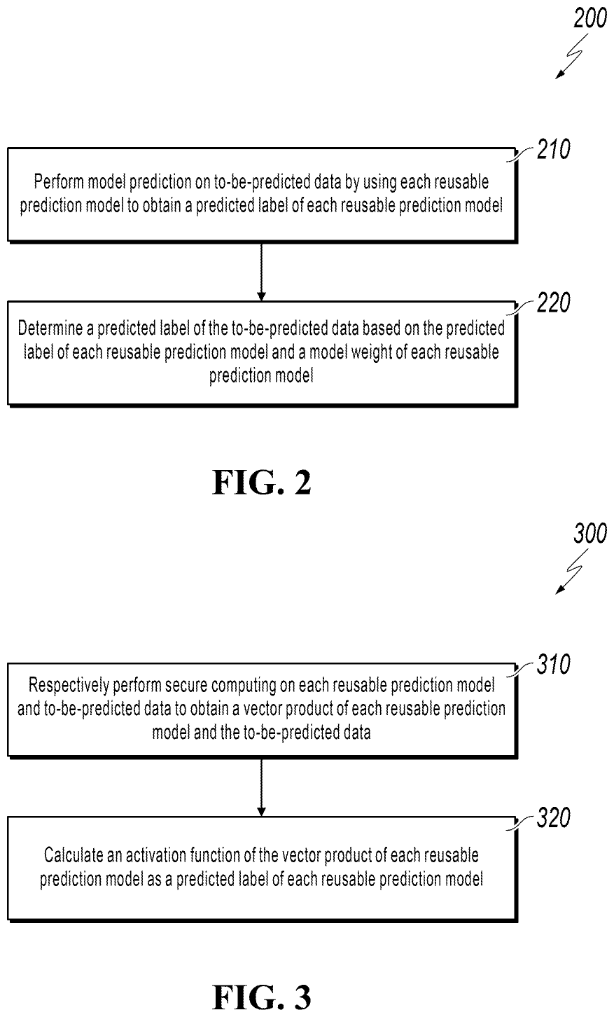

FIG. 2 is a flowchart illustrating an example of a model reuse-based model prediction method 200, according to embodiments of the present specification.

As shown in FIG. 2, in 210, to-be-predicted data of a data owner is respectively predicted by using each of multiple reusable prediction models of a model owner to obtain a predicted label of each reusable prediction model. Here, for each reusable prediction model, secure computing is performed on the to-be-predicted data and the reusable prediction model between the data owner and the model owner to obtain the predicted label. In an example, an example of the secure computing can include but is not limited to secure computing based on secret sharing; secure computing based on homomorphic encryption; secure computing based on oblivious transfer; secure computing based on a garbled circuit; or secure computing based on a trusted execution environment. In the present specification, an example of the reusable prediction model can include but is not limited to a linear regression model, a logistic regression model, a neural network model, a decision tree model, a support vector machine, etc.

FIG. 3 is a flowchart illustrating an example of a model prediction process 300, according to embodiments of the present specification. In this example, the reusable prediction model is a logistic regression model, a model parameter of each reusable prediction model can be represented by using a model parameter matrix, and the to-be-predicted data is represented by using vector data (for example, a feature data vector).

As shown in FIG. 3, in 310, secure computing is respectively performed on each reusable prediction model of the model owner and the to-be-predicted data of the data owner between the data owner and the model owner to obtain a vector product of the model parameter of each reusable prediction model and the to-be-predicted data. For example, assume that there are N reusable prediction models W₁ to W_{N} and the to-be-predicted data is X, secure computing is respectively performed on W₁ to W_{N} and X to obtain Z₁=W₁*X, Z₂=W₂*X, . . . , and Z_{N}=W_{N}*X.

In 320, an activation function of the vector product of each reusable prediction model is calculated as the predicted label of each reusable prediction model. For example, assume that the activation function is a sigmoid function, sigmoid (Z₁) to sigmoid (Z_{N}) are calculated as predicted labels Y_1 to Y_N of the reusable prediction models W₁ to W_{N}.

It is worthwhile to note that the model prediction process shown in FIG. 3 is merely an example embodiment. In other embodiments of the present specification, for other types of reusable prediction models, secure computing can be performed on the to-be-predicted data and the reusable prediction models between the data owner and the model owner by using other suitable model prediction methods to obtain predicted labels.

Referring back to FIG. 2, in 220, a predicted label of the to-be-predicted data is determined based on the predicted label of each reusable prediction model and a model weight of each reusable prediction model. For example, assume that a model weight of the ith reusable prediction model is c_i and a predicted label of the ith reusable prediction model is Y_i, the predicted label of the to-be-predicted data is Y′=iᵢ₌₁^{N}(c_i*Y_i). Here, the model weight of each reusable prediction model is a model weight in a data sample set of the data owner. In an example, the model weight of each reusable prediction model can be determined by using the data sample set of the data owner before the model prediction is performed.

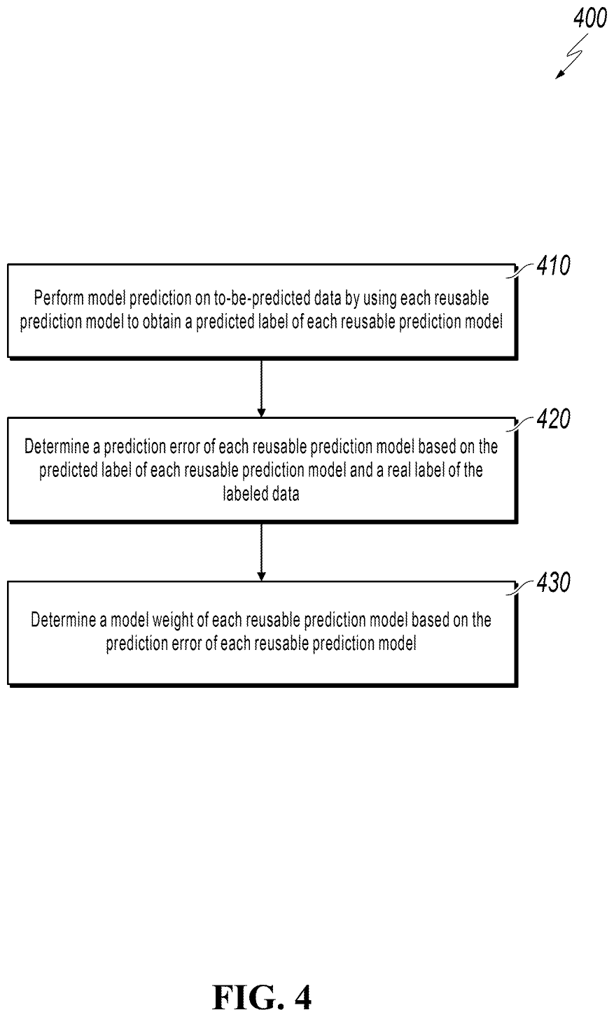

FIG. 4 is a flowchart illustrating an example of a process 400 of determining a model weight of a reusable prediction model, according to embodiments of the present specification.

As shown in FIG. 4, in 410, labeled data of the data owner is respectively predicted by using each reusable prediction model to obtain a predicted label of each reusable prediction model. A predicted label for the labeled data can be obtained by respectively performing secure computing on the labeled data and each reusable prediction model between the data owner and the model owner. For example, the predicted label of each reusable prediction model for the labeled data can be obtained in a similar way as described in FIG. 3. In an example, the labeled data can include multiple pieces of labeled data, and therefore predicted labels of the multiple pieces of labeled data can be obtained.

In 420, a prediction error of each reusable prediction model is determined based on the predicted label of each reusable prediction model and a real label of the labeled data. For example, the prediction error of the labeled data can be obtained by calculating an absolute value of a difference between the predicted label and the real label of the labeled data, that is, e_i=|Y−Y_i|, where i is the ith reusable prediction model. When the labeled data includes multiple pieces of labeled data, the prediction error of each prediction model is an average error ae i of prediction errors for the multiple pieces of labeled data.

In 430, the model weight of each reusable prediction model is determined based on the prediction error of each reusable prediction model in the data owner. For example, c_i=1−ae_i can be used as a model weight of the ith reusable prediction model. In other examples, a model weight of a reusable prediction model can be determined based on a prediction error of the reusable prediction model by using other suitable methods.

The model reuse-based model prediction method according to the embodiments of the present specification is described above with reference to FIG. 1 to FIG. 4.

In the model prediction method, secure computing is performed on each reusable prediction model of the model owner and the to-be-predicted data of the data owner to obtain the predicted label of each reusable prediction model, so that privacy security of the data of the data owner and the prediction model of the model owner can be implemented.

In addition, when model prediction is performed on the to-be-predicted data, each reusable prediction model has the model weight in the data sample set of the data owner, so that the model weight of each reusable prediction model is more in line with the data feature of the data owner, thereby improving model prediction accuracy.

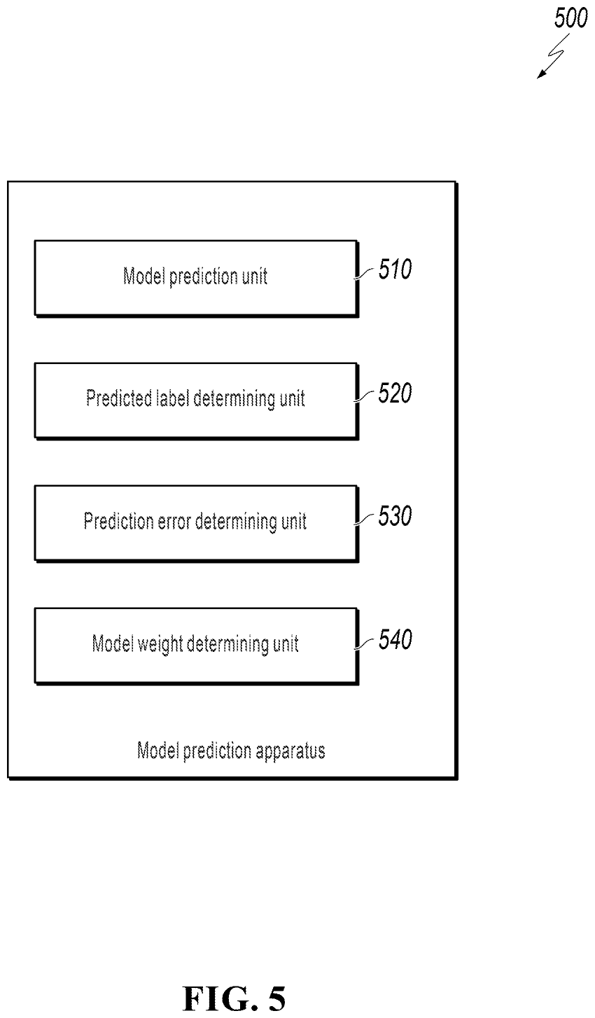

FIG. 5 is a block diagram illustrating an example of a model prediction apparatus 500 in a data owner, according to embodiments of the present specification. As shown in FIG. 5, the model prediction apparatus 500 includes a model prediction unit 510 and a predicted label determining unit 520.

The model prediction unit 510 is configured to respectively predict to-be-predicted data of a data owner by using each of multiple reusable prediction models of a model owner to obtain a predicted label of each reusable prediction model. Here, the multiple reusable prediction models have the same model input features. In addition, the predicted label is obtained by respectively performing secure computing on the to-be-predicted data and each reusable prediction model between the data owner and the model owner. For the operation of the model prediction unit 510, references can be made to the operation in 210 described above with reference to FIG. 2 and the operation described above with reference to FIG. 3.

The predicted label determining unit 520 is configured to determine a predicted label of the to-be-predicted data based on the predicted label of each reusable prediction model and a model weight of each reusable prediction model. Here, the model weight of each reusable prediction model is a model weight in a data sample set of the data owner. For the operation of the predicted label determining unit 520, references can be made to the operation in 220 described above with reference to FIG. 2.

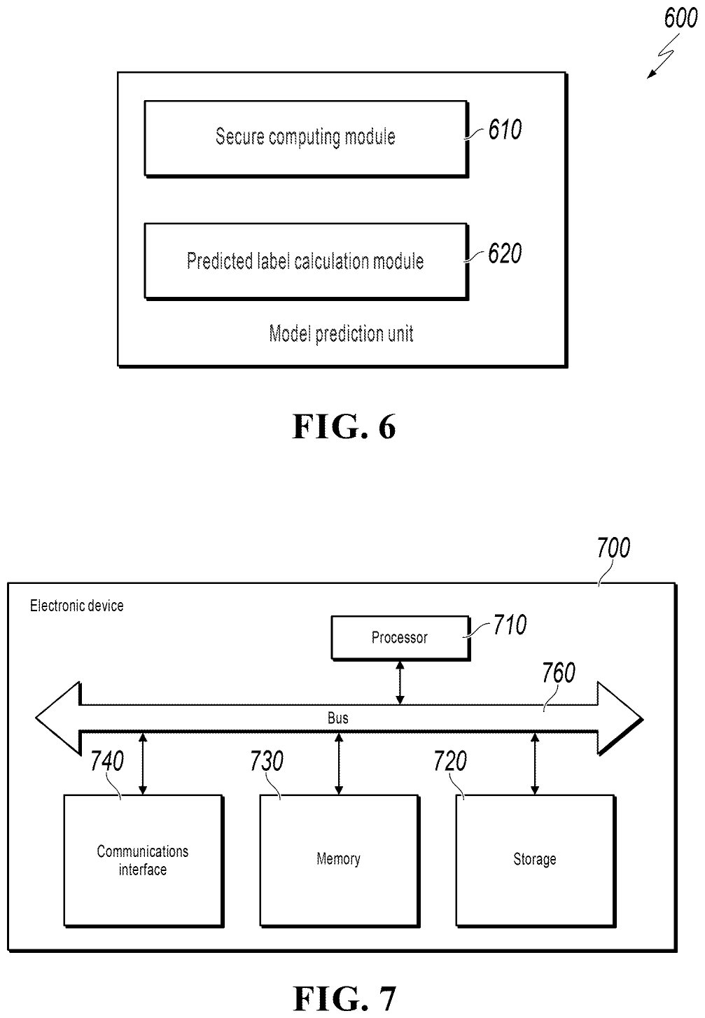

FIG. 6 is a block diagram illustrating an implementation example of a model prediction unit 600, according to embodiments of the present specification. In this implementation example, the reusable prediction model is a logistic regression model, a model parameter of each reusable prediction model can be represented by using a model parameter matrix, and the to-be-predicted data is represented by using vector data (for example, a feature data vector). As shown in FIG. 6, the model prediction unit 600 includes a secure computing module 610 and a predicted label calculation module 620.

The secure computing module 610 is configured to respectively perform secure computing on each reusable prediction model of the model owner and the to-be-predicted data of the data owner between the data owner and the model owner to obtain a vector product of the model parameter of each reusable prediction model and the to-be-predicted data.

The predicted label calculation module 620 is configured to calculate an activation function of the vector product of each reusable prediction model as the predicted label of each reusable prediction model.

In addition, optionally, the model prediction apparatus 500 can further include a prediction error determining unit 530 and a model weight determining unit 540.

The prediction error determining unit 530 is configured to determine a prediction error of each reusable prediction model based on a predicted label obtained by performing model perdition on labeled data of the data owner by using each reusable prediction model and a real label of the labeled data. Here, the predicted label of each reusable prediction model can be obtained by the model prediction unit 510 by respectively performing secure computing on the labeled data and each reusable prediction model between the data owner and the model owner. For the operation of the prediction error determining unit 530, references can be made to the operation in 420 described above with reference to FIG. 4.

The model weight determining unit 540 is configured to determine the model weight of each reusable prediction model based on the prediction error of each reusable prediction model. For the operation of the model weight determining unit 540, references can be made to the operation in 430 described above with reference to FIG. 4.

The model weight of each reusable prediction model in the data sample set of the data owner can be determined based on the model prediction unit 510, the prediction error determining unit 530, and the model weight determining unit 540.

The model prediction method, the model prediction apparatus, and the model prediction system according to the embodiments of the present specification are described above with reference to FIG. 1 to FIG. 6. The model prediction apparatus can be implemented by using hardware, or can be implemented by using software or a combination of hardware and software.

FIG. 7 is a schematic diagram illustrating an electronic device 700 configured to implement a model prediction process in a data owner, according to embodiments of the present specification. As shown in FIG. 7, the electronic device 700 can include at least one processor 710, at least one storage (for example, a non-volatile storage) 720, at least one memory 730, and at least one communications interface 740, and the at least one processor 710, the at least one storage 720, the at least one memory 730, and the at least one communications interface 740 are connected together by using a bus 760. The at least one processor 710 executes at least one computer-readable instruction (i.e., the previously described elements implemented in a software form) stored or encoded in the storage.

In some embodiments, the storage stores computer-executable instructions, and when the computer-executable instructions are executed, the at least one processor 710 is enabled to respectively predict to-be-predicted data of a data owner by using each of multiple reusable prediction models of a model owner to obtain a predicted label of each reusable prediction model, where the predicted label is obtained by respectively performing secure computing on the to-be-predicted data and each reusable prediction model between the data owner and the model owner, and the multiple reusable prediction models have the same model input features; and determine a predicted label of the to-be-predicted data based on the predicted label of each reusable prediction model and a model weight of each reusable prediction model, where the model weight of each reusable prediction model is a model weight in a data sample set of the data owner.

It should be understood that, when the computer-executable instructions stored in the storage are executed, the at least one processor 710 is enabled to perform the various operations and functions described above with reference to FIG. 1 to FIG. 6 in the embodiments of the present specification.

According to some embodiments, a program product such as a machine-readable medium (such as a non-temporary machine-readable medium) is provided. The machine-readable medium can have instructions (i.e., the previously described elements implemented in a software form). When the instructions are executed by a machine, the machine is enabled to perform the various operations and functions described above with reference to FIG. 1 to FIG. 6 in the embodiments of the present specification. Specifically, a system or an apparatus equipped with a readable storage medium can be provided, where the readable storage medium stores software program code for implementing the functions of any one of the previously described embodiments; and a computer or a processor of the system or the apparatus is enabled to read and execute instructions stored in the readable storage medium.

In this case, the program code read from the readable medium can implement the functions of any one of the previously described embodiments. Therefore, the machine-readable code and the readable storage medium that stores the machine-readable code form a part of the present specification.

Embodiments of the readable storage medium include a floppy disk, a hard disk, a magneto-optical disc, an optical disc (such as a CD-ROM, a CD-R, a CD-RW, a DVD-ROM, a DVD-RAM, a DVD-RW, or a DVD-RW), a magnetic tape, a non-volatile storage card, and a ROM. Optionally, the program code can be downloaded from a server computer or cloud by using a communications network.

A person skilled in the art should understand that various variants and modifications can be made to the embodiments disclosed above without departing from the essence of the present invention. Therefore, the protection scope of the present specification shall be limited by the appended claims.

It is worthwhile to note that not all steps and units in the previously described flowcharts and system structural diagrams are necessary, and some steps or units can be ignored based on actual needs. An execution sequence of the steps is not fixed and can be determined as needed. The apparatus structure described in the previously described embodiments can be a physical structure, or can be a logical structure, that is, some units can be implemented by the same physical entity, or some units can be implemented by using multiple physical entities or can be implemented jointly by using some components in multiple independent devices.

In the previously described embodiments, the hardware unit or module can be implemented in a mechanical way or an electrical way. For example, a hardware unit, module, or processor can include a dedicated permanent circuit or dedicated permanent circuit logic (such as a dedicated processor, an FPGA or ASIC) to complete a corresponding operation. The hardware unit or processor can further include programmable logic or a programmable circuit (such as a general purpose processor or another programmable processor), and can be temporarily set by using software to complete a corresponding operation. A specific implementation (a mechanical way, a dedicated permanent circuit, or a temporarily set circuit) can be determined based on costs and time considerations.

Example embodiments are described above in the description of embodiments illustrated with reference to the accompanying drawings, but does not represent all embodiments that can be implemented or fall within the protection scope of the claims. The term “example” used throughout the present specification means “used as an example, an instance, or an illustration”, and does not mean “preferred” or “advantageous” than other embodiments. For the purpose of providing an understanding of the described technologies, the description of embodiments includes details. However, these technologies can be implemented without these details. In some instances, well-known structures and apparatuses are shown in block diagrams in order to avoid making it difficult to understand the concepts of the described embodiments.

The previous descriptions of the content of the present disclosure are provided to enable any person of ordinary skill in the art to implement or use the content of the present disclosure. It is clear to a person of ordinary skill in the art that various modifications can be made to the content of the present disclosure. In addition, the general principle defined in the present specification can be applied to other variants without departing from the protection scope of the content of the present disclosure. Therefore, the content of the present disclosure is not limited to the examples and designs described in the present specification, but is consistent with the widest range that is in line with the principle and novelty features disclosed in the present specification.

1. A computer-implemented method, comprising:
for each reusable prediction model of a plurality of reusable prediction models having the same model input features, determining a respective model weight, by (i) using the reusable prediction model to obtain a predicted label for a sample data set of a data owner, (ii) determining a prediction error of the reusable prediction model, based on difference between the predicted label and a real label for the sample data set of the data owner, and (iii) determining the respective model weight for the reusable prediction model, based on the prediction error of the reusable prediction model, wherein the reusable prediction model comprises a logistic regression model, and a model parameter of the reusable prediction model is a model parameter matrix;
after determining the respective model weights, for each reusable prediction model of the plurality of reusable prediction models, using the reusable prediction model to obtain a respective predicted label for to-be-predicted vector data of the data owner, by performing secure computing on the reusable prediction model and the to-be-predicted vector data, between a device of the data owner and a device of an owner of the reusable prediction model, to obtain a vector product of the model parameter of the reusable prediction model and the to-be-predicted vector data, and (ii) calculating an activation function of the vector product as the respective predicted label of the reusable prediction model; and
determining the predicted label for the to-be-predicted vector data of the data owner, based on each respective predicted label of each reusable prediction model and the respective model weight of each reusable prediction model.

2. (canceled)

3. The computer-implemented method of claim 1, wherein the predicted label of the to-be-predicted vector data comprises multiple pieces of labeled data, and the prediction error of the reusable prediction model is an average error of prediction errors for the multiple pieces of labeled data.

4. The computer-implemented method of claim 1, wherein multiple, different model owners each own one or more of the plurality of reusable prediction models.

5. The computer-implemented method of claim 1, wherein the secure computing comprises:
secure computing based on secret sharing;
secure computing based on homomorphic encryption;
secure computing based on oblivious transfer;
secure computing based on a garbled circuit; or secure computing based on a trusted execution environment.

6. (canceled)

7. A non-transitory, computer-readable medium storing one or more instructions executable by a computer system to perform operations comprising:
for each reusable prediction model of a plurality of reusable prediction models having the same model input features, determining a respective model weight, by (i) using the reusable prediction model to obtain a predicted label for a sample data set of a data owner, (ii) determining a prediction error of the reusable prediction model, based on difference between the predicted label and a real label for the sample data set of the data owner, and (iii) determining the respective model weight for the reusable prediction model, based on the prediction error of the reusable prediction model, wherein the reusable prediction model comprises a logistic regression model, and a model parameter of the reusable prediction model is a model parameter matrix;
after determining the respective model weights, for each reusable prediction model of the plurality of reusable prediction models, (i) using the reusable prediction model to obtain a respective predicted label for to-be-predicted vector data of the data owner, by performing secure computing on the reusable prediction model and the to-be-predicted vector data, between a device of the data owner and a device of an owner of the reusable prediction model, to obtain a vector product of the model parameter of the reusable prediction model and the to-be-predicted vector data, and (ii) calculating an activation function of the vector product as the respective predicted label of the reusable prediction model; and
determining the predicted label for the to-be-predicted vector data of the data owner, based on each respective predicted label of each reusable prediction model and the respective model weight of each reusable prediction model.

8. (canceled)

9. The computer-readable medium of claim 7, wherein the predicted label of the to-be-predicted vector data comprises multiple pieces of labeled data, and the prediction error of the reusable prediction model is an average error of prediction errors for the multiple pieces of labeled data.

10. The computer-readable medium of claim 7, wherein multiple, different model owners each own one or more of the plurality of reusable prediction models.

11. The computer-readable medium of claim 7, wherein the secure computing comprises:
secure computing based on secret sharing;
secure computing based on homomorphic encryption;
secure computing based on oblivious transfer;
secure computing based on a garbled circuit; or
secure computing based on a trusted execution environment.

12. (canceled)

13. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
for each reusable prediction model of a plurality of reusable prediction models having the same model input features, determining a respective model weight, by (i) using the reusable prediction model to obtain a predicted label for a sample data set of a data owner, (ii) determining a prediction error of the reusable prediction model, based on difference between the predicted label and a real label for the sample data set of the data owner, and (iii) determining the respective model weight for the reusable prediction model, based on the prediction error of the reusable prediction model, wherein the reusable prediction model comprises a logistic regression model, and a model parameter of the reusable prediction model is a model parameter matrix;
after determining the respective model weights, for each reusable prediction model of the plurality of reusable prediction models, using the reusable prediction model to obtain a respective predicted label for to-be-predicted vector data of the data owner, by performing secure computing on the reusable prediction model and the to-be-predicted vector data, between a device of the data owner and a device of an owner of the reusable prediction model, to obtain a vector product of the model parameter of the reusable prediction model and the to-be-predicted vector data, and (ii) calculating an activation function of the vector product as the respective predicted label of the reusable prediction model; and
determining the predicted label for the to-be-predicted vector data of the data owner, based on each respective predicted label of each reusable prediction model and the respective model weight of each reusable prediction model.

14. (canceled)

15. The computer-implemented system of claim 13, wherein the predicted label of the to-be-predicted vector data comprises multiple pieces of labeled data, and the prediction error of the reusable prediction model is an average error of prediction errors for the multiple pieces of labeled data.

16. The computer-implemented system of claim 13, wherein multiple, different model owners each own one or more of the plurality of reusable prediction models.

17. The computer-implemented system of claim 13, wherein the secure computing comprises:
secure computing based on secret sharing;
secure computing based on homomorphic encryption;
secure computing based on oblivious transfer;
secure computing based on a garbled circuit; or
secure computing based on a trusted execution environment.

18. (canceled)
